(19) United States
(12) Patent Application Publication
(10) Pub. No.: US 2010/0260453 A1
(43) Pub. Date: Oct. 14, 2010

(54) QUALITY FACTOR (Q-FACTOR) FOR A WAVEGUIDE MICRO-RING RESONATOR

(76) Inventor: Bruce A. Block, Portland, OR (US)

Correspondence Address: INTEL CORPORATION;c/o CPA Global, P.O. BOX 52050, MINNEAPOLIS, MN, 55402, US

(21) Appl. No.: 12/420,788

(22) Filed: Apr. 8, 2009

(51) Int. Cl. G02B 6/28; G02B 6/26

(52) U.S. Cl. 385/24; 385/30

(57) ABSTRACT

The waveguide in the ring and the bus waveguide in the immediate vicinity of the ring are made wider than the optimal single mode size. The bus waveguide has adiabatic tapers which serve to connect single mode portions in the bus waveguide to the wider portion of the bus waveguide to expand the mode from the narrower waveguide to the wider waveguide. Since the light is now spread out over a larger area in the wider waveguides, the scattering loss from the sidewalls is reduced and the loss is lower. This lower loss gives rise to a higher Q in the ring since the Q of the ring is directly proportional to the round trip loss.

### FIELD OF THE INVENTION

Embodiments of the present invention are directed to optical ring resonators and, more particularly is directed to improving the Q-factor of optical ring resonators.

### BACKGROUND INFORMATION

Ring resonators are wavelength selective devices which may be used for various optical filter and modulation applications. Optical Ring Resonators (RRs) are useful components for wavelength filtering, multiplexing, switching, and modulation. The key performance characteristics of the RR include the Free-Spectral Range (FSR), the finesse or Quality factor (Q-factor), the resonance transmission, and the extinction ratio. These quantities depend not only on the device design but also on the fabrication tolerance. Although state-of-the-art lithography may not be required for most conventional waveguide designs, Ring Resonator designs involve critical dimension (CD) values at or below 100 nm.

For such designs, resolution and CD control are both important to the success of the devices. In the case of Si based ring resonators, one of the important parameters to control is the coupling efficiency between the RR and the input/output waveguide. As a compact waveguide (for example, 220 nm×500 nm strip waveguide) is usually used in the RR to obtain a large FSR, the gap between the ring and bus waveguide may only be 100-200 nm. Since the device operates through evanescent coupling, the coupling is exponentially dependent on the size of the separating gap. Thus, in order to reliably process high-Q RR devices, control of a few nm demands CD control readily achieved by modern 0.18 μm or 0.13 μm lithography.

A high Q factor is desirable for many ring resonator applications such as filters, modulators, lasers, etc. High index waveguides are necessary for making small ring resonators. Unfortunately, high index waveguide are very sensitive to surface scattering loss, especially due to line edge roughness resulting from litho/etch patterning. This edge scattering loss can limit the Q of ring resonator devices.

Some methods to improve the Q of the ring resonators have included reflowing the waveguide material. This involves high temperature processing and a waveguide/cladding system which can tolerate the high temperatures. Another technique is to oxidize a waveguide material, such as Si for example, and then remove the oxide with hydrogen fluoride (HF) or other selective etchant. Unfortunately, both of these methods are dependent in the waveguide fabrication process and entail additional cost and effort.

### BRIEF DESCRIPTION OF THE DRAWINGS

The foregoing and a better understanding of the present invention may become apparent from the following detailed description of arrangements and example embodiments and the claims when read in connection with the accompanying drawings, all forming a part of the disclosure of this invention. While the foregoing and following written and illustrated disclosure focuses on disclosing arrangements and example embodiments of the invention, it should be clearly understood that the same is by way of illustration and example only and the invention is not limited thereto.

FIG. 1 is a plan view showing one example of a ring resonator device;

FIG. 2 is a plan view of ring resonator device according to one embodiment of the invention having an expanded ring and coupler region; and

FIG. 3 is a graph showing comparing the resonant spectrums from two rings, one ring according to the invention and one ring without.

### DETAILED DESCRIPTION

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

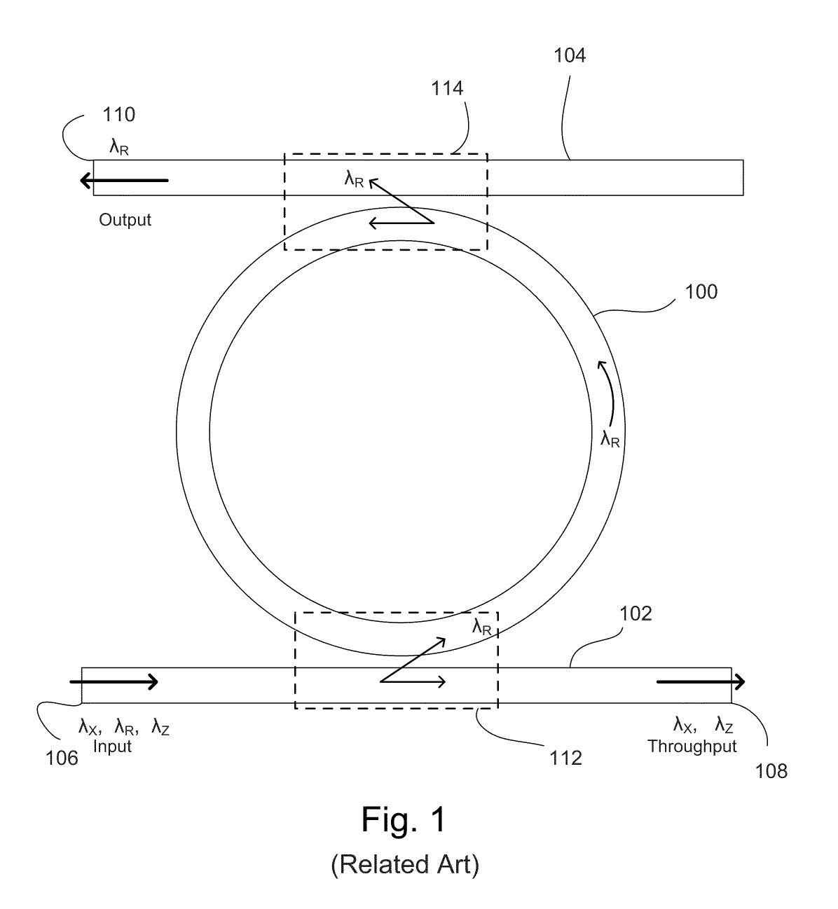

An example of a micro-ring resonator is shown in FIG. 1. The ring resonator comprises a circular waveguide, or ring, 100 evanescently coupled to a first straight waveguide 102 and a second straight waveguide 104. For purposes of illustration, the ring resonator comprises three main terminals; an input terminal 106, a throughput terminal 108, and an output terminal 110. In operation, multiple wavelengths of light are launched into the input terminal 106 of the first straight waveguide 102. Here, three wavelengths are shown, those being λx, λR, and λz. As the wavelengths pass through the first coupling area 112, they will be partially coupled into the ring 100 and the wavelengths in the ring 100 will then be in turn partially coupled at the second coupling area 114 into the second straight waveguide 104 to be output at the output terminal 110.

Thus, a ring resonator is a device which works by having a very narrow band where light of a particular wavelength is in resonance with the ring and that light gets coupled into the ring 100. Here, the resonant wavelength λR is the wavelength that is coupled into the ring 100 since it satisfies the condition λR=LNeff/m, were L is the length of the ring 100, Neff is the effective index of the ring 100 and m is an integer value. With this device, multiple wavelengths go into the ring resonator device, and all may be filtered out but the wavelength of interest, or resonant wavelength, λR.

Embodiments of the invention are directed to increasing the Q or quality factor of a waveguide micro-ring resonator. The Q is increased when the round trip loss of light is lowered in the ring. To lower the loss, the waveguide is made wider such that the intensity of light is lower at the edge of the waveguide. The edge of the waveguide typically has higher scattering loss than the top surface due to the litho/etch processing techniques used to create the waveguide.

For a good ring resonator, the waveguides should be single mode. In fiber-optic communication, a single-mode optical fiber (SMF) is an optical fiber designed to carry only a single ray of light (mode). This ray of light often contains a variety of different wavelengths. Although the ray travels parallel to the length of the fiber, it is often called the transverse mode since its electromagnetic vibrations occurs perpendicular (transverse) to the length of the fiber.

Unlike multi-mode optical fibers, single mode fibers may not exhibit modal dispersion resulting from multiple spatial modes. Single mode fibers are therefore typically better at retaining the fidelity of each light pulse over long distances. Thus, single-mode fibers can have a higher bandwidth than multi-mode fibers. A typical single mode optical fiber has a core diameter between 8 and 10 μm and a cladding diameter of 125 μm.

Using a SMF puts a limit on how wide one can fabricate the waveguides. Embodiments allow for a wider waveguide than would normally be allowed for single mode operation.

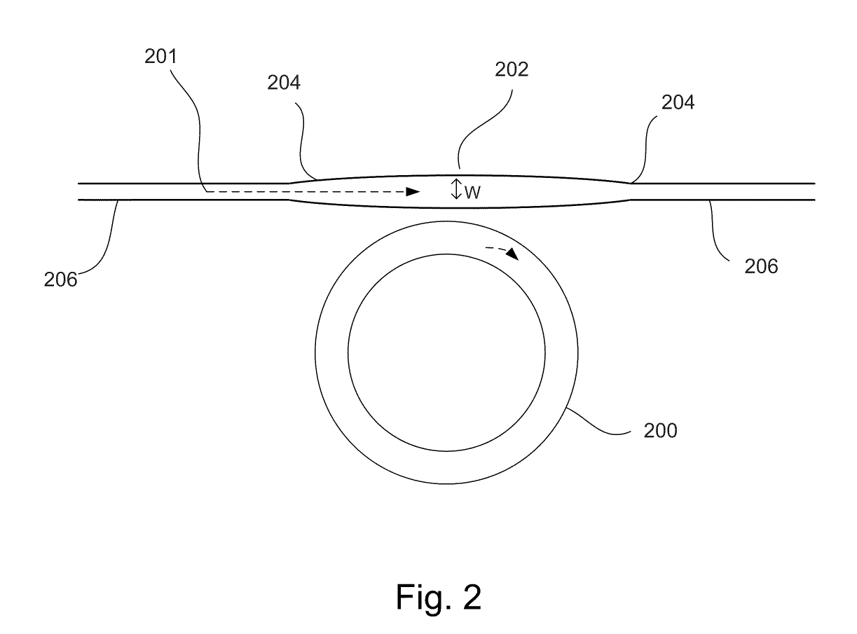

Referring now to FIG. 2, there is shown a plan view of ring resonator device according to one embodiment of the invention having an expanded ring and coupler region. The invention comprises a ring portion 200 and a bus waveguide 202 to form a waveguide based ring resonator. Light 201 may be evanescently coupled between the ring 200 and the bus waveguide 202. The waveguides in the ring and the bus waveguide in the immediate vicinity are wider (width “W”) than the optimal single mode size. The bus waveguide 202 comprises adiabatic tapers 204 which serve to connect the single mode portion (narrower waveguides) 206 in the bus waveguide 202 to the wider portion W of the bus waveguide 202.

The adiabatic tapers 204 are used to expand the mode from the narrower waveguide 206 to the wider waveguide portion W. The adiabatic tapers 204 allow the SMF width in the lateral direction to be gradually increased sufficiently slowly to allow the mode size to grow, but ensure that only a single mode is maintained even though the increased width would allow for additional modes to propagate.

The tapers 204 are designed such that there is no loss of light during the transfer, and only the primary mode of the wider waveguide is excited. When this is done, the ring may act as a normal resonator. Since the light is now spread out over a larger area in the wider waveguides W, the scattering loss from the sidewalls is reduced and the loss is lower.

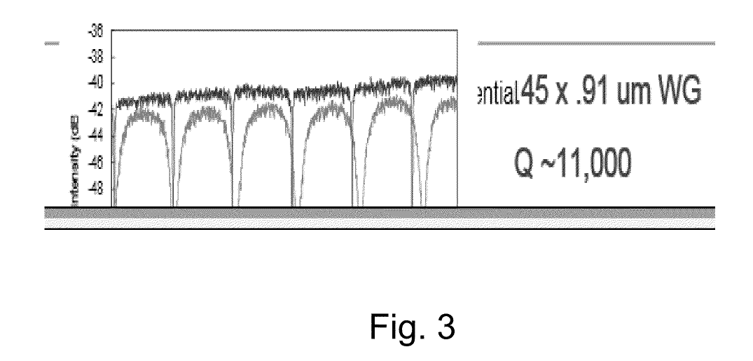

This lower loss gives rise to a higher Q in the ring 200 since the Q of the ring 200 is directly proportional to the round trip loss. FIG. 3 is a graph showing the resonance spectrum from a typical ring and a ring according to embodiments of the invention. As shown, the peaks from the inventive rings are significantly narrower than a typical ring. The Q-factor may be improved from 1,500 to 11,000 according to embodiments. The waveguide width is 0.49 um in the typical ring and 0.91 um in the ring demonstrating the invention. Note there is no evidence of having excited higher modes in the area of the expanded waveguides W because the resonance spectrum is free of secondary peaks which would indicate higher mode excitation. This is a good indication that the adiabatic tapers 204 are effective in expanding the mode without exciting higher order modes.

There are many advantages to the higher Q-factor afforded by embodiments of the invention. For example, such devices with the higher Q-factor may be used to make a more sensitive sensors, lower drive voltage modulators, and lower threshold lasers, to name a few.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. An apparatus, comprising:
an optical ring having a width; and
an optical bus evanescently coupled to the optical ring, the optical bus comprising:
a first portion having a width smaller than the width of the optical ring;
a second portion having a width smaller than the width of the optical ring; and
a middle portion between the first portion and the second portion having a width matching the width of the optical ring.

2. The apparatus as recited in claim 1 wherein the first portion of the optical bus and the second portion of the optical bus comprise a single mode optical fiber.

3. The apparatus as recited in claim 1 wherein the middle portion of the optical bus can support multiple modes.

4. The apparatus as recited in claim 3 wherein transition areas between the first portion and middle portion and the middle portion and second portion of the optical bus are tapers.

5. The apparatus as recited in claim 4 wherein the taper comprise adiabatic tapers.

6. The apparatus as recited in claim 5 wherein the adiabatic tapers prevent multiple modes in the middle portion of the optical bus.

7. The apparatus as recited in claim 5 wherein a Q-factor for the optical ring is greater than 1500.

8. The apparatus as recited in claim 5 wherein a Q-factor is between 1500 and 11,000.

9. A method, comprising:
providing an optical ring having a width; and
evanescently coupling and optical bus to the optical ring;
launching a single mode light signal into a first portion of the optical bus having a width smaller than the width of the optical ring;
providing a first tapered portion of the optical bus to expand the width of the optical bus near the optical ring; and
providing a second tapered portion of the optical bus to decrease the width of the optical bus.

10. The method as recited in claim 9 wherein the optical bus before the first taper and after the second taper comprises a single mode optical fiber.

11. The method as recited in claim 9 wherein the optical bus between the first taper and the second taper can support multiple modes.

12. The method as recited in claim 11 wherein the first taper and the second taper comprise adiabatic tapers.

13. The method as recited in claim 12 wherein the adiabatic tapers prevent multiple modes between the first taper and the second taper of the optical bus.

14. The method as recited in claim 12 wherein a Q-factor for the optical ring is greater than 1500.

15. The method as recited in claim 12 wherein a Q-factor is between 1500 and 11,000.

16. A ring resonator, comprising:
an optical ring having a width; and
an optical bus evanescently coupled to the optical ring, the optical bus comprising:
a first portion having a width less than the width of the optical ring, the first portion comprising a single mode optical fiber;
a second portion having a width less than the width of the optical ring, the second portion comprising a single mode optical fiber; and
a middle portion between the first portion and the second portion having a width matching the width of the optical ring.

17. The ring resonator as recited in claim 16 comprising adiabatic tapers between the first portion and middle portion and between the middle portion and the second portion.

18. The ring resonator as recited in claim 16 wherein the optical bus middle portion can support multiple modes.

19. The ring resonator as recited in claim 18 wherein a Q-factor for the optical ring is greater than 1500.

20. The ring resonator as recited in claim 18 wherein a Q-factor is between 1500 and 11,000.
